(19) United States
(12) Patent Application Publication
(10) Pub. No.: US 2010/0099822 A1
(43) Pub. Date: Apr. 22, 2010

(54) High impact polymeric compositions and methods of making and using same

(75) Inventor: Olga Khabashesku, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/256,258

(22) Filed: Oct. 22, 2008

(51) Int. Cl. C08L 39/04; C08L 29/00; C08L 35/06; C08L 35/04; C08L 33/10

(52) U.S. Cl. 525/203; 525/231; 525/207; 525/218; 525/221; 525/225

(57) ABSTRACT

A method comprising contacting at least one conventional elastomer, at least one singlet oxygen functionalized elastomer (SOFE), and a styrene monomer in a reaction zone under conditions suitable for the formation of a styrenic polymer composition. A method comprising contacting a reaction mixture comprising styrene, polybutadiene, and a photoperoxidized polybutadiene in a reaction zone under conditions suitable for the formation of a polymeric composition, wherein the elastomer particle size distribution in the polymeric composition does not linearly correlate with the elastomer particle size distribution in the reaction mixture. A reactor blended polymer comprising styrene, a conventional elastomer, and a singlet oxygen functionalized elastomer.

### CROSS-REFERENCE TO RELATED APPLICATIONS

The subject matter of the present application is related to U.S. Pat. No. 7,439,277 issued Oct. 21, 2008 and entitled “In-situ Preparation of Hydroperoxide Functionalized Rubber,” which is hereby incorporated herein by reference in its entirety for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

The present disclosure relates to polymeric compositions having improved mechanical properties. More specifically, this disclosure relates to high impact polymeric compositions and methods of making and using same.

2. Background

Elastomer-reinforced polymers of monovinylidene aromatic compounds such as styrene, alpha-methylstyrene, and ring-substituted styrene have found widespread commercial use. For example, elastomer-reinforced styrene polymers having discrete particles of cross-linked elastomer dispersed throughout the styrene polymer matrix can be useful for a range of applications including food packaging, office supplies, point-of-purchase signs and displays, housewares and consumer goods, building insulation, and cosmetics packaging.

The utility of a particular polymeric composition depends on the polymer having some combination of mechanical, thermal, and physical properties that render the material suitable for a particular application, such as high strength combined with high gloss. A high impact polymer composition may comprise elastomeric material comprising a distribution of particle sizes or modalities and such compositions are collectively termed multimodal polymeric compositions. Methodologies for producing a multimodal polymeric composition (e.g., bimodal) include for example the use of a polymerization system comprising multiple reactors. For example, the polymerization system may comprise three polymerization reactors; a first reactor wherein a monomer is partially polymerized in the presence of a small particle component; a second reactor wherein a monomer is partially polymerized in the presence of a large particle component; and a third reactor wherein the effluent from the first two reactors are mixed and further polymerized. Another way to produce a bimodal composition is to polymerize a mixture of two partially polymerized materials one comprising large particle components and a second comprising small particle components at a point where capsule morphology of the small particle components are already formed in the first polymeric material. Yet another way to produce a bimodal polymeric material is by mechanically mixing the polymeric materials wherein one material comprises large elastomeric components and one material comprises small particle elastomeric components to produce a blend having a bimodal distribution of particle sizes. Still another method of producing multimodal polymeric compositions comprises generating oxidizing agents within the polymerization feed that oxidize the elastomeric materials. These methods suffer from a variety of disadvantages such as the additional cost associated with physically blending a polymerized product and the potential for degradation of the polymer (e.g., yellowing, embrittlement) due to the persistence of oxidizing agents in the product. Thus, a need exists for improved methods of producing multimodal polymeric compositions.

### SUMMARY

Disclosed herein is a method comprising contacting at least one conventional elastomer, at least one singlet oxygen functionalized elastomer (SOFE), and a styrene monomer in a reaction zone under conditions suitable for the formation of a styrenic polymer composition.

Also disclosed herein is a method comprising contacting a reaction mixture comprising styrene, polybutadiene, and a photoperoxidized polybutadiene in a reaction zone under conditions suitable for the formation of a polymeric composition, wherein the elastomer particle size distribution in the polymeric composition does not linearly correlate with the elastomer particle size distribution in the reaction mixture.

Further disclosed herein is a reactor blended polymer comprising styrene, a conventional elastomer, and a singlet oxygen functionalized elastomer.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a flowchart of a method of preparing a mixed morphology polymeric composition.

FIG. 2 shows transmission electron micrographs of Sample 4 from Example 1.

FIG. 3 shows transmission electron micrographs of Sample 5 from Example 1.

FIG. 4 is a plot of the volume as a function of the elastomer particle size distribution for Sample 5 from Example 1.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are methods for the production of a polymeric composition comprising a styrenic polymer and at least two elastomers wherein the elastomers differ in mean particle size. In an embodiment, at least one elastomer is functionalized via reaction with singlet oxygen and is hereinafter denoted a singlet oxygen functionalized elastomer (SOFE). In an embodiment, at least one elastomer is prepared in the absence of singlet oxygen, such elastomers are hereinafter referred to as conventional elastomers. In some embodiments, the SOFE and the conventional elastomer differ in mean particle size. The polymeric composition comprising at least one conventional elastomer, at least one SOFE, and a styrenic polymer may display a mixed morphology resulting in user-desired mechanical and/or physical properties. Hereinafter, polymeric compositions of the type described herein are termed mixed morphology polymer compositions (MMPC).

In an embodiment, the MMPC comprises a styrenic polymer wherein the styrenic polymer may be a styrenic homopolymer or a styrenic copolymer. Styrene, also known as vinyl benzene, ethyenylbenzene, and phenylethene is an organic compound represented by the chemical formula C₈H₈. Styrene is widely commercially available and as used herein the term styrene (and the styrenic polymer formed there from) includes a variety of substituted styrenes (e.g., alpha-methyl styrene), ring-substituted styrenes such as p-methylstyrene, disubstituted styrenes such as p-t-butyl styrene as well as unsubstituted styrenes.

In an embodiment, a styrenic polymer suitable for use in this disclosure may have a melt flow rate as determined in accordance with ASTM D-1238 of from 1.7 g/10 min. to 15 g/10 min., alternatively from 2.5 g/10 min. to 9.2 g/10 min., and alternatively from 2.6 g/10 min. to 3.4 g/10 min.; a falling dart impact strength as determined in accordance with ASTM D-3029 of from 75 in-lb to 160 in-lb, alternatively from 90 in-lb to 130 in-lb, and alternatively from 100 in-lb to 125 in-lb; an Izod impact strength as determined in accordance with ASTM D-256 of from 0.8 ft-lbs/in to 5.5 ft-lbs/in, alternatively from 1.8 ft-lbs/in to 2.1 ft-lbs/in, and alternatively from 2 ft-lbs/in to 2.2 ft-lbs/in; a tensile modulus as determined in accordance with ASTM D-638 of from 1.92×10⁵ psi to 2.68×10⁵ psi, alternatively from 2.22×10⁵ psi to 2.32×10⁵ psi, and alternatively from 2.15×10⁵ psi to 2.22×10⁵ psi; a tensile strength at yield as determined in accordance with ASTM D-638 of from 2400 psi to 5000 psi, alternatively from 2400 psi to 4900 psi, and alternatively from 2400 psi to 4100 psi; an elongation at yield as determined in accordance with ASTM D-638 of from 40% to 70%, alternatively from 40% to 60%, alternatively from 45% to 50%; a tensile strength at break as determined in accordance with ASTM D-638 of from 2800 psi to 4800 psi, alternatively from 3000 psi to 4500 psi, alternatively from 3300 psi to 3600 psi; a flexural modulus as determined in accordance with ASTM D-790 of from 2.07×10⁵ psi to 3.7×10⁵ psi, alternatively from 2.4×10⁵ psi to 3.7×10⁵ psi, alternatively from 2.5×10⁵ psi to 3.5×10⁵ psi; a heat distortion as determined in accordance with ASTM D-648 of from 190° F. to 206° F., alternatively from 195° F. to 206° F., alternatively from 201° F. to 206° F.; a Vicat softening as determined in accordance with ASTM D-1525 of from 200° F. to 220° F., alternatively from 200° F. to 210° F., alternatively from 202° F. to 210° F.

In an embodiment, the styrenic polymer is present in an amount of from 1.0 to 99.9 weight percent by total weight of the MMPC (wt. %), alternatively from 5 wt. % to 99 wt. %, alternatively from 10 wt. % to 95 wt. %. In an embodiment, the styrenic polymer comprises the balance of the MMPC when other ingredients are accounted for.

In some embodiments, the styrenic polymer is a styrenic copolymer comprising styrene and one or more comonomers. Examples of such comonomers may include without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds which contain two polymerizable double bonds such as divinylbenzene or butanediol diacrylate; or combinations thereof. The comonomer may be present in an amount effective to impart one or more user-desired properties to the composition. Such effective amounts may be determined by one of ordinary skill in the art with the aid of this disclosure. For example, the comonomer may be present in the styrenic polymer in an amount ranging from 1 wt. % to 99.9 wt. % by total weight of the MMPC, alternatively from 1 wt. % to 90 wt. %, alternatively from 1 wt. % to 50 wt. %.

In an embodiment, the MMPC comprises a conventional elastomer. The conventional elastomer may be a conjugated diene monomer. Examples of suitable conjugated diene monomers include without limitation 1,3-butadiene, 2-methyl-1,3-butadiene, 2-chloro-1,3 butadiene, 2-methyl-1,3-butadiene, 2-chloro-1,3-butadiene, and combinations thereof. Alternatively, the conventional elastomer may be an aliphatic conjugated diene monomer. Without limitation, examples of suitable aliphatic conjugated diene monomers include C₄ to C₉ dienes such as butadiene monomers, or combinations thereof. Blends or copolymers of the diene monomers may also be used. In an embodiment, the conventional elastomer comprises a homopolymer of a diene monomer; alternatively the conventional elastomer comprises polybutadiene.

In an embodiment, the conventional elastomer comprises polybutadiene, alternatively a combination of high and/or medium and/or low cis polybutadiene. Herein the designation cis refers to the stereoconfiguration of the individual butadiene monomers wherein the main polymer chain is on the same side of the carbon-carbon double bond contained in the polybutadiene backbone as is shown in Structure I:

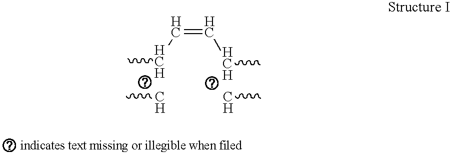

Conventional elastomers (e.g., polybutadiene) suitable for use in this disclosure may be further characterized by a low vinyl content. Herein a low vinyl content refers to less than 5 wt. % of the material having terminal double bonds of the type represented in Structure II:

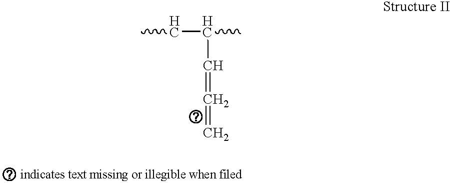

Such conventional elastomers may be prepared by any suitable means for the preparation of high and/or medium and/or low cis content conventional elastomers (e.g., polybutadiene). For example, the conventional elastomers may be prepared through a solution process using a transition metal or alkyl metal catalyst.

Examples of conventional elastomers suitable for use in this disclosure include without limitation DIENE-55 (D-55) and Firestone-645 (F-645), both of which are commercially available from Firestone. In an embodiment, the conventional elastomer (e.g., D-55) has generally the physical properties set forth in Table 1.

TABLE 1

| | | | |
|---|---|---|---|
| Properties | Min. | Max | Test Method |

Raw Polymer Properties

| | | | |
|---|---|---|---|
| Mooney Viscosity | 39 | 49 | DIN 53 523 |
| UML 1 + 4 (100° C.) (MU) | | | |
| Volatile matter (wt %) | | 0.5 | ASTM D 5668 |
| Total ash (wt %) | | 0.5 | ASTM D 5667 |
| Organic acid (5) | | 1.0 | ASTMD 5774 |

Cure Characteristics⁽¹⁾⁽²⁾

| Minimum torque (dN, m) | 2.3 | 3.3 | ISO 6502 |
|---|---|---|---|
| Maximum Torque, S′ max. | 16.7 | 21.3 | ISO 6502 |
| (dN, m) | | | |
| tₛ1 (min) | 2.2 | 3.2 | ISO 6502 |
| t′50 (min) | 5.9 | 8.7 | ISO 6502 |
| Other Product Features | | Typical Value | |
| Cis 1,4-content | | 96 | |
| Specific Gravity | | 0.91 | |
| Stabilizer Type | | Non-staining | |

The conventional elastomer may be present in amounts effective to produce one or more user-desired properties. Such effective amounts may be determined by one of ordinary skill in the art with the benefits of this disclosure. The amount of conventional elastomer may depend on the amount of other elastomers present in the MMPC as will be described in more detail later herein.

In an embodiment, the MMPC comprises a SOFE. The SOFE may be prepared by any suitable method. For example, the SOFE may be prepared by allowing singlet oxygen to react with a substrate comprising a hydrocarbon having at least one double bond to produce an oxidized substrate. A method of preparing a SOFE may comprise contacting a catalyst with molecular oxygen to generate an activated oxygen species and contacting the activated oxygen species with a hydrocarbon substrate.

In an embodiment, the catalyst comprises a photosensitizer. A photosensitizer, also referred to herein as the donor, refers to a light-absorbing substance that may be photoexcited and used to create an excited state in another molecule, also referred to herein as the acceptor molecule. For example, a photosensitizer (i.e., donor) when exposed to a light source may undergo photoexcitation and subsequently contact other molecules (i.e., acceptors) and transfer at least a portion of its energy to generate molecules having an excited electronic state.

In an embodiment, the donor comprises any material whose excited state is at a higher energy than the acceptor and is capable of transferring energy to the acceptor. Alternatively, the donor comprises a photosensitive dye. Suitable photosensitive dyes include without limitation xanthene dyes, illustrative examples of which are rose Bengal, rhodamine B, erythrosin, eosin and fluorescein; thiazine dyes, an example of which is methylene blue; acridines, an example of which is acridine orange; or combinations thereof.

In an embodiment, the catalyst further comprises a support material supporting one or more donor materials such as a photosensitive dye. Typical support materials may include talc, inorganic oxides, clays and clay minerals, ion-exchanged layered compounds, diatomaceous earth compounds, zeolites or a resinous support material, such as a polyolefin, for example. Alternatively, the support material comprises silica, alumina, or combinations thereof. Such supports may be in form of pellets and/or beads having any variety of shapes and/or sizes. In some embodiments, the support material for a photosensitizer may be a translucent material. In an embodiment, the support material comprises silica having a surface area of equal to or greater than 100 m²/g, alternatively equal to or greater than 150 m²/g, alternatively equal to or greater than 500 m²/g. In another embodiment, the support material comprises alumina having a surface area of equal to or greater than 200 m²/g, alternatively equal to or greater than 300 m²/g, alternatively equal to or greater than 400 m²/g.

A catalyst comprising a photosensitizer and a support may be photoexcited by exposure to a light source and contacted with at least one acceptor molecule to produce an excited acceptor molecule. In an embodiment, the acceptor molecule comprises molecular oxygen and the excited acceptor molecule comprises singlet oxygen.

Singlet oxygen, designated ¹O₂, is the common name used for the two metastable states of molecular oxygen with a higher energy than the ground state, triplet oxygen. The two metastable states of ¹O₂ differ only in the spin and occupancy of oxygen's two degenerate antibonding π-orbitals. The O₂(b¹Σ_{g}⁺) excited state is very short lived and relaxes quickly to the lowest lying excited stated, O₂(a¹Δ_{g}). Thus, the O₂(a¹Δ_{g}) state is commonly referred to as singlet oxygen. ¹O₂ may be generated by any suitable method. Singlet oxygen may then be used to form SOFEs of the type described herein.

Hydroperoxides are formed in the reaction between singlet oxygen and olefins possessing an allylic hydrogen according to a concerted “ene” mechanism that requires that the double bond of the olefin be cleanly shifted into the allylic position. In an embodiment, the substrate comprises a diene having at least one allylic hydrogen, alternatively a 1,3-diene having at least one allylic hydrogen.

Examples of suitable SOFEs include without limitation peroxidized elastomers such as peroxidized polybutadiene; hydroperoxidized elastomers such as hydroperoxidized polybutadiene; or combinations thereof. Methods for the preparation of SOFEs are disclosed in U.S. patent application Ser. No. 11/835,126 filed Aug. 7, 2007 and entitled “Singlet Oxygen Oxidized Materials and Methods of Making and Using Same,” which is incorporated by reference in its entirety.

The SOFE may be present in amounts effective to produce one or more user-desired properties. Such effective amounts may be determined by one of ordinary skill in the art with the benefits of this disclosure. For example, the SOFE may be present in the MMPC in an amount ranging from 2.5 wt. % to 11.5 wt. % by total weight of the MMPC, alternatively from 4 wt. % to 6 wt. %, alternatively from 5 wt. % to 5.5 wt. %.

In an embodiment, the MMPC may also comprise additives as deemed necessary to impart desired physical properties, such as, increased gloss or color. Examples of additives include without limitation chain transfer agents, talc, antioxidants, UV stabilizers, photosensitive dye agent, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. The abovementioned additives may be included in amounts effective to impart the desired properties. Effective additive amounts and processes for inclusion of these additives to polymeric compositions would be apparent one skilled in the art with the benefit of this disclosure. For example, one or more additives may be added after recovery of the MMPC, for example during compounding such as pelletization. Alternatively or additionally to the inclusion of such additives in the styrenic polymer component of the MMPC, such additives may be added during formation of the MMPC or to one or more other components of the MMPC.

In an embodiment, the MMPC comprises a mixture of conventional elastomers and SOFEs. In such embodiments, the ratio of conventional elastomer:SOFE present in the MMPC may be from 1:10 to 10:1, alternatively from 1:5 to 5:1, alternatively from 1:1 to 1:4.

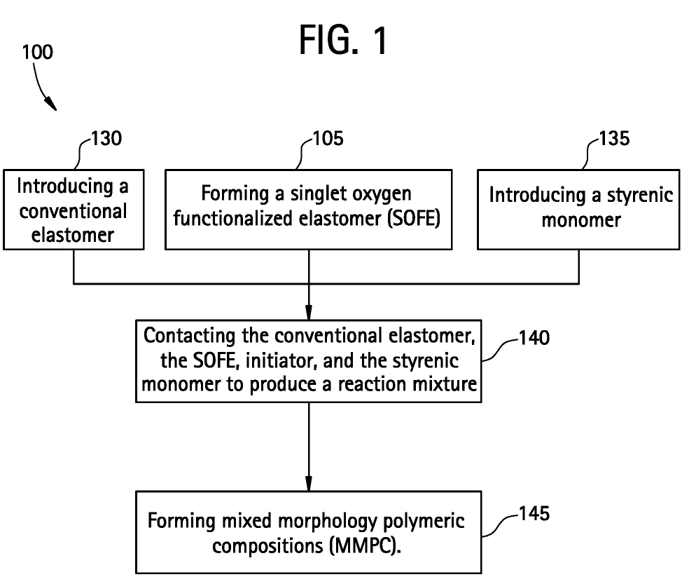

In an embodiment, a method of preparing an MMPC is depicted in FIG. 1. The method may comprise contacting styrene monomer, a conventional elastomer, a SOFE, and other components all of the type previously described herein, in one or more polymerization reactors upstream of a first extruder. The contacting may be carried out under conditions suitable for the polymerization of these materials and the resulting product is a reactor blended polymer. Referring to FIG. 1, the method 100 may initiate with providing a SOFE (Block 105), for example a photoperoxidized polybutadiene. The method 100 may further comprise introducing a conventional elastomer (Block 130) and a styrenic monomer (Block 135) along with the SOFE to a reaction zone. Suitable conventional elastomers and styrenic monomers have been described previously herein. In an embodiment, the SOFE, the conventional elastomer, and the styrenic monomer are fed into the reactor zone from separate feed lines (e.g., a SOFE feed line, a conventional elastomer feed line, and a styrenic monomer feed line). The method 100 may further comprise contacting the conventional elastomer, the SOFE, and the styrenic monomer to produce a reaction mixture (Block 140). Contacting of the reagents (e.g., conventional elastomer, SOFE, and styrenic polymer) may be carried out in any order desired by the user and compatible with the process. For example, the MMPC may be prepared by initially contacting a conventional elastomer with a SOFE and then subsequently contacting with a styrenic monomer. Alternatively, the conventional elastomer may be contacted with the styrenic monomer and then subsequently contacted with the SOFE. Alternatively, the SOFE may be contacted with the styrenic monomer and then subsequently contacted with the conventional elastomer. In an alternative embodiment, a conventional elastomer, a SOFE, and a styrenic monomer are contacted simultaneously, for example within a reaction zone. In such an embodiment, the conventional elastomer, the SOFE, and the styrenic monomer may be fed to the reaction zone through separate feed lines (e.g., a SOFE feed line, a conventional elastomer feed line, and a styrenic monomer feed line). In some embodiments, one or more additives may be added to the reaction zone. The additives may be added through a separate additive feed line, alternatively the additives may be pre-contacted with the conventional elastomer by adding the additive to the conventional elastomer feed line, alternatively pre-contacted with the SOFE by adding the additive to the SOFE feed line, alternatively pre-contacted with the styrenic monomer by adding the additive to the styrenic monomer feed line, or combinations thereof.

The method 100 may further comprise polymerizing the reaction mixture in a reaction zone under conditions suitable for the formation of a polymeric composition (Block 145). During polymerization, a phase separation based on the immiscibility of the styrenic polymer (e.g., polystyrene), the conventional elastomer (e.g., polybutadiene), and the SOFE (e.g., photoperoxidized polybutadiene) occurs in two stages. Initially, polybutadiene (both the conventional and photoperoxidized polybutadiene) forms the major or continuous phase with styrene dispersed therein. As the reaction progresses and the amount of polystyrene continues to increase, a morphological transformation or phase inversion occurs such that polystyrene now forms the continuous phase and polybutadiene and styrene monomer form the discontinuous phase. This phase inversion leads to the formation of the discontinuous phase comprising complex elastomeric particles in which the elastomer exists in the form of polybutadiene membranes surrounding occluded domains of polystyrene.

In an embodiment, the MMPC production process employs at least one polymerization initiator. In an embodiment, the peroxide groups present on the SOFE serve as internal polymerization initiators. In an alternative embodiment, the MMPC production process employs external polymerization initiators. Such external polymerization initiators may function as a source of free radicals to enable the polymerization of styrene. In an embodiment, any initiator capable of free radical formation that facilitates the polymerization of styrene may be employed. Such initiators include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides, t-butylperoxy isopropyl carbonate, or combinations thereof. In an embodiment, the initiator level in the reaction is given in terms of the active oxygen in parts per million (ppm). In an embodiment, active oxygen level is from 20 ppm to 80 ppm, alternatively from 20 ppm to 60 ppm, alternatively from 30 ppm to 60 ppm. As will be understood by one of ordinary skill in the art, the selection of initiator and effective amount will depend on numerous factors (e.g., temperature, reaction time) and can be chosen by one of ordinary skill in the art with the benefits of this disclosure to meet the desired needs of the process. Polymerization initiators and their effective amounts have been described in U.S. Pat. Nos. 6,822,046; 4,861,827; 5,559,162; 4,433,099 and 7,179,873, each of which are incorporated by reference herein in their entirety. Referring to FIG. 1, in an embodiment the initiator may be introduced when the other reagents (e.g., conventional elastomer, SOFE, and styrenic monomer) are contacted at block 140. Alternatively, the initiator may be contacted with the other components at any point compatible with the needs of the process.

In an alternative embodiment, the MMPC is prepared in the presence of a singlet oxygen generating material. Such materials are known to one of ordinary skill in the art (e.g., phosphite ozonide, chlorine and basic hydrogen peroxide) and may form singlet oxygen under the conditions to which the MMPC is exposed. In an embodiment, an inconsequential amount of the singlet oxygen generating material is used in the preparation of the MMPC. Herein, an inconsequential amount refers to an amount of singlet oxygen generating material that reacts with a conventional elastomer to generate less than about 1% of the total SOFE present in the MMPC. Further, an inconsequential amount may allow a majority of the MMPC (e.g., greater than 95%) to retain the properties described later herein (e.g., multimodal, increased Izod impact strength, increased ductility factor). In an embodiment, the singlet oxygen generating materials are present in an amount that minimizes the adverse properties associated with their presence such as photoaging, yellowing, discoloration or embrittlement of the final polymeric material.

The polymerization process can be either batch or continuous. In an embodiment, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed in U.S. Pat. No. 4,777,210, which is incorporated by reference herein in its entirety.

The temperature ranges useful with the processes of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. In an embodiment, a polymerization reactor for the production of an MMPC of the type disclosed herein comprising a plurality of reactors may have the first reactor (e.g., a CSTR), also known as the prepolymerization reactor, operated in the temperature range of from 90° C. to 135° C. while the second reactor (e.g., CSTR or plug flow) may be operated in the range of from 100° C. to 165° C. In an embodiment, a polymerization process for the production of an MMPC of the type disclosed herein may be carried out in a batch reactor operated at a temperature of 100° C. for two hours, 130° C. for one hour, and 150° C. for one hour.

The polymerized product effluent from the first reactor may be referred to herein as the prepolymer. When the prepolymer reaches the desired conversion, it may be passed through a heating device into a second reactor for further polymerization. The polymerized product effluent from the second reactor may be further processed as is known to one of ordinary skill in the art and described in detail in the literature. Upon completion of the polymerization reaction, an MMPC is recovered and subsequently processed, for example devolatized, pelletized, etc.

The MMPC may have a complex elastomer particle size distribution which without wishing to be limited by theory may not linearly correlate with the percentage of conventional and SOFE elastomer used to prepare the composition. For example, a polymeric composition prepared using a conventional elastomer of the type described herein may display an average elastomeric particle size of 3.5 microns. In contrast, polymeric compositions prepared using a SOFE typically display an average elastomeric particle size of less than 1 micron. The distribution of particle sizes in the MMPCs of this disclosure may vary such that the particle size ranges from 1 micron to 3.5 microns. Further, the amount of a particular elastomer particle size in the final composition may not be linearly related to the amount of that particular elastomer particle size in the feed.

For example, a styrenic polymer composition being prepared from a feed that forms 50% elastomer particle size A and 50% elastomer particle that forms size B would be expected to produce a final composition comprising 50% elastomeric particle size A and 50% elastomeric particle size B. The final composition in this example may be characterized as having a particle size distribution profile that is bimodal and further characterized by a bimodal morphology.

In a second example, a styrenic polymer composition prepared as described herein (i.e., MMPC) may be prepared from a feed comprising 50% of a conventional elastomer that forms particle size C and 50% of a SOFE that forms particle size D when added to styrene monomer and polymerized. In this example, the final composition may be characterized by a particle size distribution wherein 80% of the elastomers have particle size C and 20% have particle size D. Consequently, the final composition has a elastomer particle size distribution that is not linearly related to the elastomer distribution in the feed. The final composition (i.e., MMPC) has a particle distribution profile that is characterized as a mixed morphology. The particle size distribution may influence the final mechanical and/or physical properties of the composition, and thus the particle size distribution may be adjusted by one of ordinary skill in the art with the benefits of this disclosure to obtain MMPCs with user desired properties.

The MMPCs of this disclosure may be converted to end-use articles by any suitable method. In an embodiment, this conversion is a plastics shaping process such as blowmoulding, extrusion, injection blowmoulding, injection stretch blowmoulding, thermoforming, and the like. Examples of end use articles into which the MMPC may be formed include food packaging, office supplies, plastic lumber, replacement lumber, patio decking, structural supports, laminate flooring compositions, polymeric foam substrate; decorative surfaces (e.g., crown molding, etc.) weatherable outdoor materials, point-of-purchase signs and displays, house wares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth.

In an embodiment, the MMPC produced according to this disclosure displays a broad elastomer particle size (also termed rubber particle size, RPS) distribution when compared to a polymeric composition comprising either a conventional elastomer alone or a SOFE alone. The elastomer particle size distribution in the MMPC may range from 0.1 microns to 5 microns, alternatively from 0.1 microns to 4.5 microns, alternatively from 1.2 microns to 4 microns and may be determined using any technique suitable for determining particle size such as for example, transmission electron microscopy and/or standard laser light scattering technique. An example of a light scattering technique includes without limitation the use of a MASTERSIZER 2000 integrated system for particle sizing, which is commercially available from Malvern Instruments.

In an embodiment, the MMPC produced according to this disclosure displays a reduced ligament length when compared to a polymeric composition comprising either a conventional elastomer alone or a SOFE alone. Herein the ligament length refers to the distance between the elastomer particles observed by electron microscopy techniques in the final composition.

In an embodiment, the MMPC may display a swell index of from 10% to 17%, alternatively from 11% to 16%, alternatively from 12% to 15%, as determined in accordance with ASTM D3616. Swell index can be used to measure the extent of interfacial bonding (crosslinking) between polystyrene and elastomer (i.e., polybutadiene). Swell index may be determined by taking the ratio of the mass of the moist gel to the mass of the dry gel.

Articles constructed from an MMPC of the type described herein may display improved mechanical, physical, and/or optical properties.

In an embodiment, an article constructed from an MMPC of the type described herein displays an improved impact strength as reflected in an increase in the Izod impact strength of greater than 40%, alternatively greater than 45, 50, 55, 60, 65, or 70% when compared to a polymeric composition comprising either a conventional elastomer alone or a SOFE alone. Izod impact strength is defined as the kinetic energy needed to initiate a fracture in a specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promote a brittle rather than ductile fracture. Specifically, the Izod impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, and sample toss energy). In an embodiment, the article may exhibit an Izod impact strength of equal to or greater than 2 ft-lb/in, alternatively of from 2 ft-lb/in to 3 ft-lb/in, alternatively equal to or greater than 3 ft-lb/in, as determined in accordance with ASTM D256.

In an embodiment, an article constructed from an MMPC of the type described herein displays an improved elastomer (i.e., polybutadiene) utilization as reflected in an increase in the Izod to polybutadiene ratio (also termed Izod to rubber ratio or the ductility factor of equal to or greater than 20%, alternatively 25, 30, 35, or 40% when compared to a polymeric composition comprising either a conventional elastomer alone or a SOFE alone. In an embodiment, the article may exhibit an Izod to rubber ratio of equal to or greater than 3, alternatively equal to or greater than 4.

In an embodiment, an article constructed from an MMPC of the type described exhibits a tensile modulus of from 3×10⁵ psi to 3.5×10⁵ psi, alternatively from 3×10⁵ psi to 3.4×10⁵ psi, alternatively from 3×10⁵ psi to 3.2×10⁵ psi, as determined in accordance with ASTM D638. The tensile modulus is the ratio of stress to elastic strain in tension. Therefore, the larger the tensile modulus the more rigid the material, and the more stress required to produce a given amount of strain.

In an embodiment, an article constructed from an MMPC of the type described herein displays a tensile strength at yield of from 4,000 psi to 5,500 psi, alternatively from 4,100 psi to 5,400 psi, alternatively from 4,200 psi to 5,200 psi, as determined in accordance with ASTM D638. The tensile strength at yield is the force per unit area required to yield a material.

In an embodiment, an article constructed from an MMPC of the type described herein displays a tensile strength at break (also termed yield/break strength) of from 4,000 psi to 4,500 psi, alternatively from 4,100 psi to 4,400 psi, alternatively from 4,200 psi to 4,250 psi, as determined in accordance with ASTM D638. In an embodiment, an article constructed from an MMPC of the type described herein displays a tensile elongation at break (also termed elongation at yield/break) of from 5% to 40%, alternatively from 10% to 25%, alternatively from 20% to 30%, as determined in accordance with ASTM D638.

The tests to determine tensile properties may be carried out in the machine direction (MD), which is parallel to the direction of polymer orientation and/or the transverse direction (TD), which is perpendicular to the direction of polymer orientation. The tensile strength at break is the force per unit area required to break a material. The tensile elongation at break is the percentage increase in length that occurs before a material breaks under tension.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The mechanical properties of several MMPCs were investigated. Three control samples comprising styrene, or styrene and a conventional elastomer or styrene and SOFE Samples 1, 2, and 3 respectively. Additionally, two MMPC samples comprising styrene, an elastomer, and a SOFE (Samples 4 and 5) were prepared as described below. The conventional elastomer feeds comprised the medium-cis polybutadiene DIENE-55 and the high-cis polybutadiene F-645, both of which are commercially available from Firestone. Sample 1 was prepared using a 4 wt. % solution of D-55 in styrene with 170 parts per million (ppm) of tert-butylperoxy isopropyl carbonate (TBIC), which is a polymerization initiator commercially available from Aldrich.

For Samples 2 and 3, SOFEs were prepared by photoperoxidizing a 4% solution of D-55 in styrene and F-645 in styrene respectively. The photoperoxidation was carried out using a glass chromatography column (15 mm inside diameter×300 mm) that was irradiated with halogen light and ambient light (71 ft candles from one side and 29 ft candles from other side). The column was filled with silica supported Rose Bengal (Aldrich, 98%) photocatalyst. The silica support was high surface are silica from Aldrich #43860 and the photocatalyst loading was 0.266 milligrams per gram of support. Each sample (Samples 2 and 3) was poured in the glass column sparged with air that was passed through the catalyst column at a flow rate of 1.6 liters per minute (L/min) for 6 hours. The column was then drained and the photoperoxidized sample was collected.

Sample 4 was prepared by blending 25% of a 4 wt. % solution of D-55 in styrene and 75% of photoperoxidized 4 wt. % solution of D-55 in styrene. Sample 5 was prepared by blending 25% of a 4 wt. % solution of D-55 in styrene and 75% of a photoperoxidized 4 wt. % solution of F-645 in styrene. The details of the feeds for Samples 1 to 5 are tabulated in Table 2.

TABLE 2

| | | Photoperoxidized | Photoperoxidized | |
|---|---|---|---|---|
| Sample | 4% D-55 | 4% D-55 | 4% F-645 | Initiator |
| 1 | 100% | — | — | 170 ppm |
| | | | | ]. TBIC |
| 2 | — | 100% | — | None |
| 3 | — | — | 100% | None |
| 4 | 25% | 75% | — | None |
| 5 | 25% | — | 75% | None |

All samples were then polymerized by a batch process. The temperature profile used was 100° C. for two hours, 130° C. for one hour, and 150° C. for one hour. The mechanical properties of all samples were determined in accordance with previously referenced methodologies and the results are tabulated in Table 3.

TABLE 3

| Description | Sample 1 | Sample 2 | Sample 3 | Sample 4 | Sample 5 |
|---|---|---|---|---|---|
| Izod impact, ft-lb/in | 0.71 | 2.01 | 0.4 | 3.21 | 3.57 |
| Rubber, % | 5.86 | 5.98 | 6.51 | 7.26 | 7.28 |
| Izod to Rubber ratio | 0.12 | 0.34 | 0.06 | 0.44 | 0.49 |
| Tensile Yield, psi | 5534 | 6701 | 6723 | 5298 | 4292 |
| Tensile Break, psi | 4746 | 6090 | 6658 | 4225 | 4207 |
| Tensile Modulus, ×10⁵ psi | 2.84 | 3.51 | 3.64 | 3.16 | 3.09 |
| Swell Index, % | 15.4 | 7.9 | 13.2 | 11.79 | 14.4 |
| RPS, microns | 3 | 2.4 | 3.8 | 2.9 | 3.8 |

The results demonstrate that the Izod impact strengths determined for Samples 4 and 5 (MMPCs of the type described herein) are higher than that determined for Samples 1, 2, and 3 (control samples). Samples 4 and 5 displayed large increases in the Izod impact strength when compared to the control samples (i.e., Samples 1, 2, and 3). These increases in Izod impact strength (for example from 0.71 ft-lb/in for Sample 1 to 3.2 ft-lb/in. for Sample 4) were unexpected as the samples displayed comparable RPS. Additionally, the Izod to rubber (i.e., polybutadiene) ratios for Samples 4 and 5 are higher than those of Samples 1, 2, and 3. The improved Izod to rubber ratios for Samples 4 and 5 suggests that peroxidizing only part of the elastomer/styrene feed resulted in desirable properties.

### Example 2

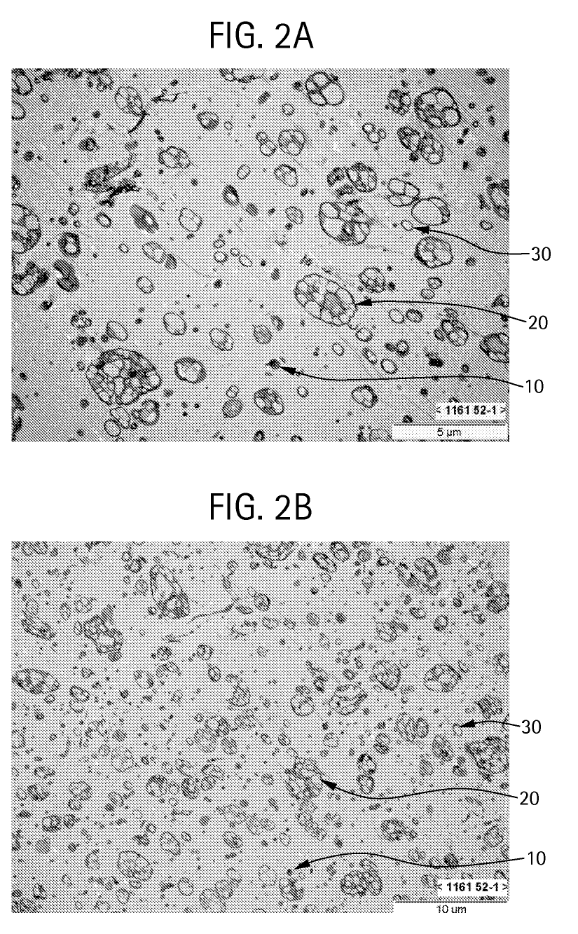

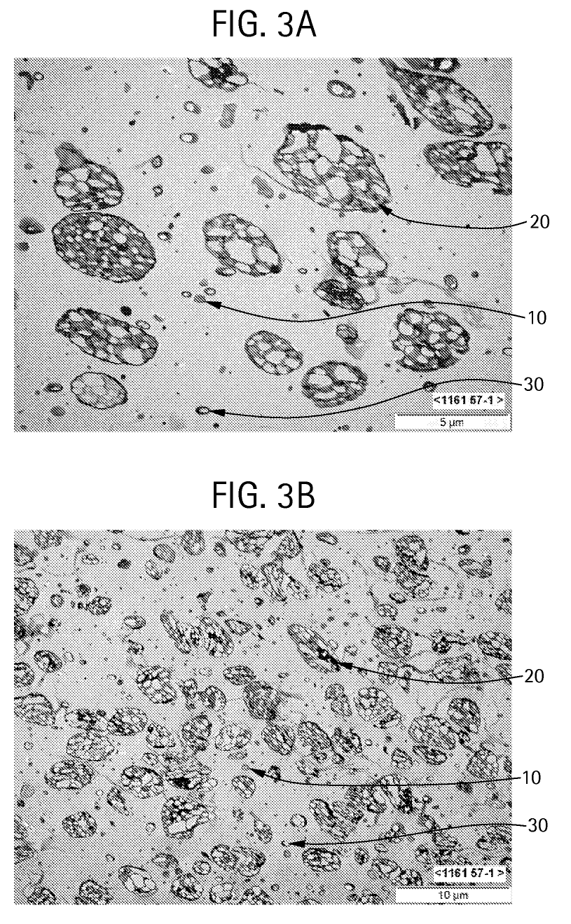

The morphology of the MMPC produced in Example 1 was investigated. FIGS. 2 and 3 are transmission electron micrographs that depict the morphologies of the MMPC (Samples 4 and 5 respectively) obtained via Transmission Electron Microscopy (TEM). FIGS. 2 and 3 each depict 2 micrographs of samples A and B, respectively. The scale of each micrograph is denoted in the figure.

Referring to FIGS. 2A and 3A, particles of the type indicated by 10 are polybutadiene particles, which show as dark circles in the TEM. Particles of the type indicated by 20 are irregularly shaped complex particles having several occlusions of polystyrene (clear) with a polybutadiene membrane (dark). The morphology of particle 20 is best characterized as a salami morphology. These large particles, 20, have an average size of 3.5 microns. Particles of the type indicated by 30 are examples of a polystyrene particle with a core-shell morphology. Specifically, such particles have a clear polystyrene core and a dark polybutadiene membrane or shell surrounding the polystyrene. These small particles, 30, have an average size of less than 1 micron. Without wishing to be limited by theory, the addition of 75% photo peroxidized elastomer (i.e., polybutadiene) to a conventional styrenic composition would be expected to result in particles of the type indicated by reference arrow 30 comprising approximately 75% of the composition. However, as shown in FIGS. 2 and 3, the ratio of large particles 20 to small particles 30 does not correspond linearly to the feed ratio of 25% conventional elastomer to 75% SOFE (i.e., photoperoxidized elastomer). The morphology of the MMPC produced by the methodologies disclosed herein can be described as a mixed morphology. By comparing FIGS. 2 and 3, it was observed that Sample 5 prepared with a high cis peroxidized elastomer (F-645) had an increased number of larger sized particles when compared to Sample 4 prepared with a low cis peroxidized elastomer (D-55).

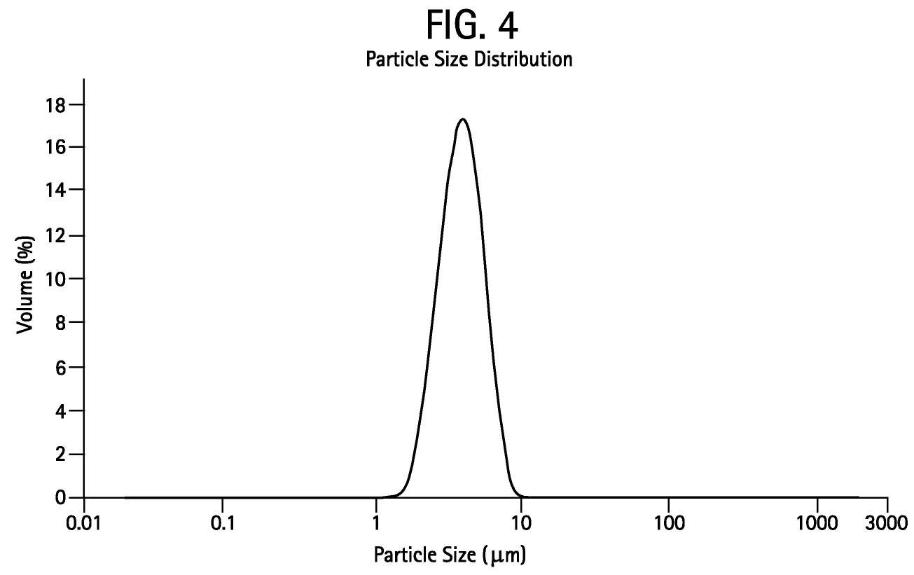

FIG. 4 is a chart of elastomer particle size (also termed Rubber Particle Size RPS) distribution of Sample 5 from Example 1. A MASTERSIZER 2000 integrated system which uses a standard laser light scattering technique for determination of particle size particle sizing was used to determine the volume as a function of RPS. The MASTERSIZER 2000 is commercially available from Malvern Instruments. Referring to FIG. 4, Sample 5 had an average particle size of 3.8 microns and a particle size span of 0.891 microns. The ligament length in Sample 4 is also shorter than the ligament length observed in Sample 5. The ligament length refers to the distance between elastomer particles and is an indication of the ability of the particle to resist the formation of crazes or cracks.

While embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R═R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The disclosures of all patents, patent applications, and publications cited herein are hereby incorporated by reference, to the extent that they provide exemplary, procedural, or other details supplementary to those set forth herein.

1. A method comprising: contacting at least one conventional elastomer, at least one singlet oxygen functionalized elastomer (SOFE), and a styrene monomer in a reaction zone under conditions suitable for the formation of a styrenic polymer composition; wherein the ratio of conventional elastomer to singlet oxygen functionalized elastomer comprises from 1:5 to 5:1.

2. The method of claim 1 wherein the conventional elastomer comprises conjugate diene monomer, C₄ to C₉ diene, homopolymer of diene monomer, polybutadiene, or combinations thereof.

3. The method of claim 1 wherein the conventional elastomer comprises high cis polybutadiene, medium cis polybutadiene, low cis polybutadiene, or combinations thereof.

4. The method of claim 1 wherein the conventional elastomer comprises polybutadiene having a vinyl content of less than 5%.

5. The method of claim 1 wherein the singlet oxygen functionalized elastomer is prepared by contacting a conventional elastomer with singlet oxygen.

6. The method of claim 5 wherein the conventional elastomer comprises conjugate diene monomer, C₄ to C₉ diene, homopolymer of diene monomer, polybutadiene, or combinations thereof.

7. The method of claim 1 wherein the singlet oxygen functionalized elastomer comprises peroxidized polybutadiene, hydroperoxidized polybutadiene, or combinations thereof.

8. The method of claim 1 wherein the styrenic polymer composition comprises a homopolymer or a copolymer.

9. The method of claim 1 wherein the styrene monomer comprises styrene, substituted styrenes, ring-substituted styrenes, halogenated styrenes, alkylated styrenes, or combinations thereof.

10. The method of claim 1 further comprising a comonomer wherein the comonomer comprises acrylonitrile, esters of (meth)acrylic acid with C1 to C8 alcohols, N-vinyl compounds, vinvicarbazole, maleic anhydride, divinylbenzene, butanediol diacrylate, or combinations thereof.

11. The method of claim 1 wherein the singlet oxygen functionalized elastomer is present in an amount of from 2.5 wt.% to 11.5 wt.% based on the total weight of the styrenic polymer composition.

12. (canceled)

13. The method of claim 1 wherein a styrenic polymer is incorporated in an amount of from 1.0 wt.% to 99.9 wt.% based on the total weight of the styrenic polymer composition.

14. The method of claim 1 wherein the styrenic polymer composition has a mixed morphology.

15. The method of claim 1 wherein the styrenic polymer composition has a swell index of from 10% to 17%.

16. The method of claim 1 further comprising forming the styrenic polymer composition into an article.

17. The method of claim 16 wherein the article has an Izod impact strength of equal to or greater than 2 ft-lb/in.

18. The method of claim 16 wherein the article has an Izod to rubber ratio of equal to or greater than 3.

19. The method of claim 16 wherein the article has a tensile modulus of from 3×10⁵ psi to 3.5×10⁵ psi.

20. The method of claim 16 wherein the article has a tensile strength at yield of from 4,000 psi to 5,500 psi.

21. The method of claim 16 wherein the article has a tensile strength at break of from 4,000 psi to 4,500 psi.

22. The method of claim 16 wherein the article has a tensile elongation at break of from 5% to 40%.

23. A method comprising contacting styrene, polybutadiene, and a photoperoxidized polybutadiene in a reaction zone under conditions suitable for the formation of a polymeric composition, wherein the elastomer particle size distribution in the polymeric composition does not linearly correlate with the elastomer particle size distribution in the reaction mixture, and wherein the ratio of conventional elastomer to singlet oxygen functionalized elastomer comprises from 1:5 to 5:1.

24. A reactor blended polymer comprising styrene, a conventional elastomer, and a singlet oxygen functionalized elastomer, wherein the ratio of conventional elastomer to singlet oxygen functionalized elastomer comprises from 1:5 to 5:1.

25. The polymer of claim 24 having an Izod impact strength of equal to or greater than 2 ft-lb/in.

26. The polymer of claim 24 having an Izod to rubber ratio of equal to or greater than 3.
